(19) United States
(12) Patent Application Publication
(10) Pub. No.: US 2015/0242878 A1
(43) Pub. Date: Aug. 27, 2015

(54) METHOD FOR ALLOWING A DISCOUNT ON GOODS AND SERVICES ON THE INTERNET

(71) Applicant: Phillip Geoffrey COOK, Saltsjobaden (SE)

(72) Inventor: Phillip Geoffrey COOK, Saltsjobaden (SE)

(73) Assignee: TRIG MEDIA GROUP AB, Nacka Strand (SE)

(21) Appl. No.: 14/300,507

(22) Filed: Jun. 10, 2014

(30) Foreign Application Priority Data
Feb. 26, 2014 (SE) 1450221-5

(51) Int. Cl. G06Q 30/02

(52) U.S. Cl. CPC G06Q 30/0222

(57) ABSTRACT

Method for allowing discounts on goods and services when trading over the Internet, which method includes a server of a seller of goods or services, the seller's server, for marketing the goods or services in question, an additional central server arranged to include information about which objects are discounted by the seller, and the computer or telephone of a user, connected to the Internet. The central server is provided with an application arranged to be transferred to the computer or telephone of the user, the application is arranged to indicate discounted objects on the homepage of the search engine or the seller using an icon, when the user has been connected via the Internet to the server of the seller, a transaction including a discount is caused to be created in case the user selects the icon on the screen of his or her computer or telephone.

### FIELD OF THE INVENTION

The present invention relates to a method for allowing a discount on goods and services when trading over the Internet.

### BACKGROUND OF THE INVENTION

Online purchases via the Internet increase heavily. Presently, a household purchases on average for EUR 2.000 annually. After fifteen years of marketing on and via the Internet, a symbiosis has developed between publishers and those offering goods and services on the Internet (the providers). The importance of merchandising and marketing through publishers and other connected networks has increased while conventional ads in the printed media have had to take a step back.

Publishers receive good remuneration in case their publication of an ad or the corresponding results in a transaction, but receive nothing in case their publication does not lead to a transaction.

If for instance a travel agency has an ad on a homepage for travels or tourist destinations, a user can click on the ad and thereby end up on the homepage of the travel agent.

Knowledge about if a user participates in a transaction or not can for instance accrue by a user seeing an ad for an airline on a homepage for a travel magazine and clicks his or her way further from the homepage of the travel magazine to the homepage to which the ad relates. Thereby, the information can be given to the party to whom the ad pertains.

By using publishers, the exposure of ads can be made very broad as compared to conventional ads.

The party that in the end pays for the service which is performed on the Internet by publishers and others is the party who offers a good or a service.

There are companies that act as a middleman between the user and the party offering a good or a service. Such a company can negotiate with the provider about a discount, such as for instance for selected travel destinations. In case such a middleman, a trader, negotiates discounts with a travel agent for selected travel destinations, the middleman must be able to state which travel destinations that are allowed a discount and which travel destination that a user selects to purchase, when the user has seen an ad about there being discounted travels with a travel agent and the user clicks into the homepage of the travel agent.

Hereby, it is desirable that the travel agent on short notice can select which travel destinations and hotels that are on discount, so as to control the demand.

The middleman must receive information that a travel has been purchased and what discount was allowed.

Moreover, there is a central part collecting information regarding discounted offers and which stores information regarding what discounted objects that have been sold and to whom.

Suitably, the said middleman administrates and distributes the allowed discount to involved parties. Instead of the middleman performing this, it may be performed by the central part.

One problem is to, on the respective homepage of a search engine for goods or services, state which objects that are discounted without changing the homepage itself. It is therefore desired to be able to, on a homepage, state which object or objects that is or are currently discounted without the seller having to change its homepage.

### SUMMARY OF THE INVENTION

The present invention solves this problem, and admits that a discounted object is indicated on the homepage of a search engine or seller.

Hence, the present invention relates to a method for allowing discounts on goods and services when trading over the Internet, which method comprises a server at a search engine or a seller of goods or services, the seller's server, for marketing of the good or service in question, and an additional central server arranged to comprise information about which objects are discounted by the seller, as well as the computer or telephone of a user, connected to the Internet, and is characterized in that the central server is provided with an application arranged to be transferred to the computer or telephone of the user, in that the application is arranged to indicate discounted objects on the homepage of the search engine or the seller using an icon, when the user has been connected via the Internet to the server of the seller, in that a transaction comprising a discount is caused to be created in case the user selects the said icon on the screen of his or her computer or telephone.

### BRIEF DESCRIPTION OF THE DRAWINGS

Below, the invention is described in closer detail, partly in connection to an embodiment of the invention which is illustrated in the enclosed drawings, wherein

FIG. 1 shows a block diagram illustrating the invention.

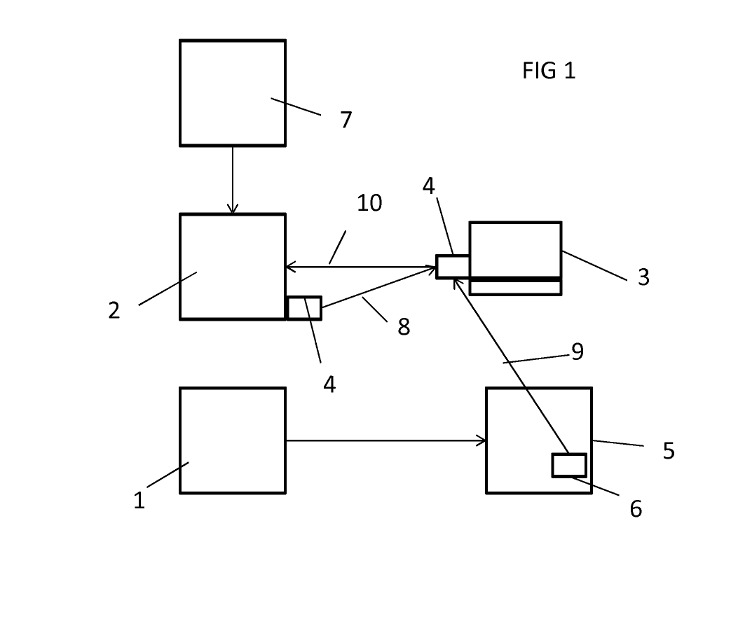

### DETAILED DESCRIPTION OF THE INVENTION

Method for allowing discounts on goods and services when trading over the Internet, which method comprises a server 1 of a seller of goods or services, the seller's server, for marketing of the good or service in question, and a central server 2 arranged to comprise information about which objects are discounted by the seller, as well as a computer 3 or telephone of a user, connected to the Internet.

According to the invention, the central server 2 is provided with an application 4, that is a computer program, which is arranged to be transferred to the web browser of the user in the computer 3 or telephone of the user, as illustrated by arrow 8. The application 4 is arranged to indicate discounted objects on the homepage 5 of the search engine or the seller using an icon 6, when the user has connected him- or herself via the Internet to the server 1 of the seller. A transaction comprising a discount is caused to be created in case the user selects the said icon 6 on the screen of his or her computer 3 or telephone. The transaction is created by the application in the computer 3 of the user transferring information to the central server 2, as illustrated by arrows 9, 10.

According to a very preferred embodiment, the said icon 6 is displayed on the said homepage 5 at a discounted object without the said homepage 5 being changed. This can be achieved by the said icon 6 being displayed superposed onto the homepage of the seller.

According to a preferred embodiment, the computer 3 or the telephone of the user is caused to retrieve the said application from the central server 2 and thereby to send the IP address of the computer 3 or telephone of the user to the central server 2.

A non-limiting example may be that a user desires to purchase a travel. The user connects for instance to the homepage of a search engine. From this it is then not clear which travels are allowed a discount. Thereafter, the user connects to the central server 2 and downloads an application 4 which is stored on the central server 2 to its web browser. Hereby, the said application is caused to, on the homepage of the travel agent and using an icon 6 or the corresponding, indicate the travels that are allowed a discount. In case the user wishes to purchase a discounted travel, the user clicks on the icon at the travel in question. Information regarding that the user has purchased the said travel is transferred from the computer or telephone of the user to the central server 2.

Hereby, a transaction comprising a discount is created. The transaction comprises payment of the travel, including debiting of the user and the transfer of remuneration from the travel agent to the party controlling the central server 2.

According to another preferred embodiment, the transaction comprises, after the good or service has been paid at a non-discounted price, that the seller is caused to be invoiced the discount, and that the discount is shared between the user and at least the party controlling the central server 2.

Above, the invention has been exemplified with the purchase of a travel. However, the present invention is not limited to purchases of travels, but may be used for purchasing any type of goods or services being sold on the Internet and marketed by an affiliate network.

According to an additional embodiment, there is an additional party, namely a so-called trader. According to this embodiment, there is a server 7 belonging to a so called trader. This server 7 comprises information regarding what objects that are allowed a discount. In this embodiment, the task of the trader is to negotiate with the seller regarding discounts or to store information from the seller regarding discounts offered by the seller. The server 7 of the trader is caused to transfer, to the central server 2, which goods or services that are allowed a discount. A transaction comprising a discount or refund is caused to be created in case the user marks the said icon 6 on the screen of his or her computer 3 or telephone, whereby the transaction, after the good or service has been paid for at a non-discounted price, comprises that the server 7 of the trader is caused to invoice the seller for the discount, and the discount is shared between the user, the trader and the party controlling the central server 2.

There may be more involved parties, such as publishers and other advertising media. Such actors are tied together in a conventional manner.

Above, a number of embodiments have been described. However, the flows of information are changed to alternative paths without departing from the basic idea of the invention, using an icon without the homepage itself being changed.

Hence, the present invention may be varied.

Therefore, the present invention is not to be considered limited to the above described embodiments, buy may be varied within the scope of the enclosed claims.

1. Method for allowing discounts on goods and services when trading over the Internet, which method comprises a server (1) of a search engine or a seller of goods or services, the seller's server, for marketing of the good or service in question, and an additional central server (2) arranged to comprise information about which objects are discounted by the seller, as well as the computer (7) or telephone of a user, connected to the Internet, characterized in that the central server (2) is provided with an application arranged to be transferred to the computer (7) or telephone of the user, in that the application is arranged to indicate discounted objects on the homepage (5) of the search engine or the seller using an icon (6), when the user has been connected via the Internet to the server (1) of the seller, in that a transaction comprising a discount is caused to be created in case the user selects the said icon (6) on the screen of his or her computer or telephone.

2. Method according to claim 1, characterized in that the transaction, after the good or service has been paid for at a non-discounted price, comprises that the seller is invoiced the discount and in that the discount is shared between the user and at least the party controlling the central server (2).

3. Method according to claim 1, characterized in that the computer (7) or the telephone of the user is caused to retrieve the said application from the central server (2) and thereby is caused to send the IP address of the computer (7) or telephone of the user to the central server (2).

4. Method according to claim 1, characterized in that the said icon (6) is displayed on the said homepage (5) by a discounted object without the said homepage being changed.

5. Method according to claim 4, characterized in that the said icon (6) is displayed superposed onto the homepage (5) of the search engine or the seller.

6. Method according to claim 1, characterized in that a server (7) belonging to a so called trader is present, comprising information regarding what objects that are allowed a discount, in that the server (7) of the trader is caused to transfer, to the central server (2), which goods or services that are allowed a discount, in that a transaction comprising a discount is caused to be created in case the user marks the said icon (6) on the screen of his or her computer (3) or telephone, whereby the transaction, after the good or service has been paid for at a non-discounted price, comprises that the server (7) of the trader is caused to invoice the seller for the discount, and in that the discount is shared between the user, the trader and the party controlling the central server.

7. Method according to claim 2, characterized in that the computer (7) or the telephone of the user is caused to retrieve the said application from the central server (2) and thereby is caused to send the IP address of the computer (7) or telephone of the user to the central server (2).

8. Method according to claim 2, characterized in that the said icon (6) is displayed on the said homepage (5) by a discounted object without the said homepage being changed.

9. Method according to claim 3, characterized in that the said icon (6) is displayed on the said homepage (5) by a discounted object without the said homepage being changed.

10. Method according to claim 2, characterized in that a server (7) belonging to a so called trader is present, comprising information regarding what objects that are allowed a discount, in that the server (7) of the trader is caused to transfer, to the central server (2), which goods or services that are allowed a discount, in that a transaction comprising a discount is caused to be created in case the user marks the said icon (6) on the screen of his or her computer (3) or telephone, whereby the transaction, after the good or service has been paid for at a non-discounted price, comprises that the server (7) of the trader is caused to invoice the seller for the discount, and in that the discount is shared between the user, the trader and the party controlling the central server.

11. Method according to claim 3, characterized in that a server (7) belonging to a so called trader is present, comprising information regarding what objects that are allowed a discount, in that the server (7) of the trader is caused to transfer, to the central server (2), which goods or services that are allowed a discount, in that a transaction comprising a discount is caused to be created in case the user marks the said icon (6) on the screen of his or her computer (3) or telephone, whereby the transaction, after the good or service has been paid for at a non-discounted price, comprises that the server (7) of the trader is caused to invoice the seller for the discount, and in that the discount is shared between the user, the trader and the party controlling the central server.

12. Method according to claim 4, characterized in that a server (7) belonging to a so called trader is present, comprising information regarding what objects that are allowed a discount, in that the server (7) of the trader is caused to transfer, to the central server (2), which goods or services that are allowed a discount, in that a transaction comprising a discount is caused to be created in case the user marks the said icon (6) on the screen of his or her computer (3) or telephone, whereby the transaction, after the good or service has been paid for at a non-discounted price, comprises that the server (7) of the trader is caused to invoice the seller for the discount, and in that the discount is shared between the user, the trader and the party controlling the central server.

13. Method according to claim 5, characterized in that a server (7) belonging to a so called trader is present, comprising information regarding what objects that are allowed a discount, in that the server (7) of the trader is caused to transfer, to the central server (2), which goods or services that are allowed a discount, in that a transaction comprising a discount is caused to be created in case the user marks the said icon (6) on the screen of his or her computer (3) or telephone, whereby the transaction, after the good or service has been paid for at a non-discounted price, comprises that the server (7) of the trader is caused to invoice the seller for the discount, and in that the discount is shared between the user, the trader and the party controlling the central server.
